(19) United States
(12) Patent Application Publication
(10) Pub. No.: US 2010/0320649 A1
(43) Pub. Date: Dec. 23, 2010

(54) METHOD AND DEVICE FOR THE PRODUCTION OF A THREE-DIMENSIONAL OBJECT MADE OF A MATERIAL WHICH CAN BE COMPACTED

(75) Inventor: Frank Niebling, Ulm (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/528,456

(22) PCT Filed: Dec. 11, 2007
(86) PCT No.: PCT/EP07/10836

§ 371 Date: Oct. 1, 2009

(30) Foreign Application Priority Data
Feb. 26, 2007 (DE) 10 2007 009 273.5

(51) Int. Cl. B29C 35/08

(52) U.S. Cl. 264/460; 425/78

(57) ABSTRACT

The invention relates to a method and a device according to rapid technology for the production of a three-dimensional object made of a powdery material, which can be compacted, wherein additional temperature control is carried out in the available space by passing a temperature-controlled fluid through the powder.

The invention relates to a method and a device for the production of a three-dimensional object made of a material which can be compacted. Such methods and devices are known, for example from DE 10108612 C1 or DE 102005041559. In this case, the compactable material may be pulverulent, as, for example, in DE 10108612 C1, or fluid, as in DE 102005041559.

DE 10108612 C1 relates to what is known as selective laser sintering (SLS). SLS is a rapid technology method in which a platform (construction space bottom) lowerable into a construction space carries a powder layer which is heated in selected regions by means of a laser beam, so that the powder particles fuse together to form a first layer. Subsequently, the platform is lowered downward into the construction space by about to 200 μm (depending on the particle size and the type of particle), and a new powder layer is applied. The laser beam marks its path again and fuses the powder particles of the second layer together and also the second layer together with the first layer, and a compacted three-dimensional object, for example an injection mold, is formed therein. Sometimes, the construction space is also appreciated as a whole or superficially, in order to reduce the additional introduction of energy necessary for sintering.

Similarly, in the rapid technology method of 3D printing (3DP, 3-dimensional printing), a platform (construction space bottom) lowerable into a construction space carries a powder layer which is sprayed in selected regions by a liquid jet, with the result that the powder particles are dissolved (etched) or induced into a chemical reaction with one another, so that the powder particles bond to form a first layer. In this case, as a result of the reaction, heating may likewise occur. Directed preheating is also possible in 3DP in order, for example, to increase the reaction rate.

Likewise similarly, in stereolithography, radiation-sensitive fluid layers are compacted by irradiation. In this case, irradiation usually takes place by means of UV radiation, but also by means of IR radiation or liquid jets, for example according to DE 102005044920 A1. Heating may likewise occur in this case.

Sometimes, instead of using energy beams or liquid jets having a closely limited area, irradiation is also carried out over a large area by means of masks, for example in selective mask sintering (SMS), according to EP 1015214 B1. Heating may likewise occur in this case.

Inside the construction space, specific regions, depending on the geometry of the component to be produced, experience the abovementioned heating by irradiation for a longer or shorter period of time, whereas other regions are not heated due to this. Moreover, only in each case the uppermost material layer is heated by the irradiation, the lower layers discharge the absorbed heat into their surroundings and cool. This results in inhomogeneous temperature distributions and thermal stresses within the layer cake, and these may lead to component distortion. In SMS, depending on the material used, a preheating of the entire construction space may be necessary. This is the case, for example, with PA12. In the middle of the construction space, above all, a heat accumulation may in this case occur, so that the powder cake, overall, becomes hard.

To minimize this problem, it has already been proposed in EP 556 291 B1 to set a uniform basic temperature of the respective surface layer by means of an annular radiant heater mounted above the latter in parallel. This is intended to result in a more uniform cooling of the individual layers and therefore in lower component distortion.

Specific investigations have shown, however, that temperature gradients continue to arise within and between the individual layers, in particular the first-mentioned leading to component distortion, which is unacceptable at least where high-quality components are concerned. It is therefore proposed, in DE 10108612 C1, to heat the casing of the construction space in such a way that, in the casing, a temperature distribution is established which, starting from the regions of the casing which are contiguous to the last-sintered surface of the layer cake, decreases in the direction of the construction space bottom.

The component distortion is thereby largely restricted. For special applications, however, there is still need for improvement.

In addition to component distortion, the material costs also play an ever greater part with an increasing number of the components which are generated. Consequently, the powder material which has not bonded is reused as far as possible after component generation. In the case of many materials, particularly polymeric materials, thermal degradation which rises with the duration of thermal load prevents such reuse. The aim, therefore, is to cool the layer cake as quickly as possible, but as uniformly as possible.

The object on which the invention is based is to specify a method and a device for the production of a three-dimensional object made of a pulverulent material which can be compacted, in which the component distortion as a result of temperature gradients and also the thermal degradation of the powder material are largely restricted.

The invention is reproduced, with regard to the method to be provided and the device to be provided, by means of the features of patent claims 1 and 6. Advantageous refinements and developments of both are specified by the features of the further patent claims.

The object is achieved according to the invention, in terms of the method to be provided for the production of a three-dimensional object, by means of the following steps:
application and smoothing of a compactable pulverulent material layer onto a target surface,
irradiation of a selected part of the layer with an energy beam or material jet according to a cross section of the object, so that the material layer is compacted in this selected part,
the irradiated parts and their surroundings being heated,
repetition of the application and irradiation steps for a plurality of layers which form a layer cake,
so that the compacted parts of the adjacent layers bond together in order to form the object,
characterized
in that a fluid flows at least partially through the layer cake.

The energy beam may be of any type, for example an electron beam or IR beam, preferably a laser beam, as long as the introduction of energy into the material layer is only sufficiently high to bring about a local compacting of the material layer. For this purpose, the particles of the pulverulent material do not have to fuse completely in the irradiated region. Incipient fusion or the initiation of a chemical reaction by energy may, if appropriate, likewise be sufficient. The beam may irradiate the respective layer surface in a punctiform manner or even over a large area.

If a material jet is used, both solid material (particle jet) and liquid material (liquid, suspension, emulsion, build-up welding, etc.) may be sprayed onto the material layer of the target surface.

If a liquid jet is used, it is advantageous if at least one constituent of the material layer is soluble in the liquid or, as a result of interaction with the liquid, a reaction is triggered which causes a local compaction of the material layer in the region of impingement of the liquid. The term “liquid jet” comprises not only a continuous jet, but, in particular, also individual drops.

A layer cake is understood to mean the powder cylinder applied in layers inside the construction space and containing compacted and non-compacted regions.

Since, according to the invention, a fluid flows (at least partially) through the layer cake, the otherwise low thermal conductivity of the powder heap of the layer cake is markedly increased, in that the voids between the powder particles are co-utilized for heat transport. This takes place in that heat is discharged (or introduced) by means of the fluid flowing through. Such a heat flow is, even alone, more effective than heat conduction via the powder heap and is even more so in addition to this. As a result, the temperature distribution within the layer cake is appreciably homogenized.

This homogenization of the temperature distribution within the layer cake is achieved in that the temperature distribution generated by the fluid flowing through is superposed upon the temperature distribution generated by the irradiation and, if appropriate, that generated by an annular radiant heater and/or casing heating. This additional temperature distribution should, of course, not reach temperatures which would bring about an independent compaction of the material layers. Instead, it stipulates an essentially uniform basic temperature of the individual material layers, so that the heat discharge from the irradiated regions within a layer is minimized and the heat conduction from the irradiated regions is conveyed into the depth, that is to say perpendicularly with respect to the material layers.

Preferably, throughflow takes place after the conclusion of the generative method. As a result, interactions with component generation are as far as possible ruled out. However, throughflow may also take place during generation. In that case, however, the throughflow must be comparatively low, in order to minimize influences on component generation.

The fluid may be gaseous or liquid. A liquid, as a rule, possesses a higher heat capacity and can therefore influence the temperature distribution within the layer cake to a greater extent than a gas. On the other hand, the use of a liquid requires a subsequent drying step for the powder. However, this can easily be integrated into a powder treatment which is in any case often associated. The use of a gas as a fluid flowing through influences the layer cake to a lesser extent and therefore constitutes a more careful, but slower method. Moreover, the drying step otherwise required is dispensed with.

It is also helpful to promote the throughflow by applying a vacuum on the flow outlet side of the layer cake or construction space.

Advantageously, the fluid is thermally controlled, preferably cooled. This takes place before penetration into the layer cake, preferably before entry into the construction space. Preferably, the temperature of the fluid is adapted to the temperature of the layer cake. For this purpose, the temperature of the layer cake may be measured in real time in one or more stipulated positions or may be derived from empirically determined values or values calculated by simulation. Adaptation takes place in such a way that a limit value of the temperature difference between the fluid and layer cake is not overshot, in order, for example, to minimize influences on account of thermal stresses within the layer cake. This limit value may be varied specifically to the material.

Advantageously, the temperature of the fluid is varied in time. As a result, for example, the temperature difference between the fluid and layer cake can be kept constant during the cooling of the layer cake. It is also conceivable, however, to lower the temperature difference slowly, in order to delay the cooling of particularly sensitive materials.

The fluid preferably penetrates through at least one wall of the construction space (for example, construction space bottom) having a multiplicity of inlet or outlet orifices for the fluid, preferably in such a way that orifices are closed individually and/or in groups by means of closing arrangements according to requirements. Such a wall may, for example, have a completely or partially screen-like configuration.

Advantageously, thermal control takes place differently in a plurality of preferably variable regions inside the construction space. This may take place by means of fluid streams which have different temperatures and which are introduced into the layer cake by means of various closing arrangements of those mentioned above. The regions may, for example, all lie in one layer plane of the layer cake, for other applications all the regions may advantageously be in one plane perpendicular to the layering, and, in yet other applications, even a three-dimensionally distributed arrangement of the thermal control regions may be advantageous. If the possibilities for arranging the thermal control regions are variable, all these applications may advantageously be implemented in the same device.

Thermal control may take place uniformly in all regions or even only in all regions of one plane, that is to say, in each case, a uniform temperature is transmitted to the surrounding layer material. It may, however, be even more advantageous if different thermal control takes place in different regions inside the construction space. For example, thermal control may take place as a function of the distance of the respective thermal control region from the contour of the compacted object inside the layer cake, for example a higher temperature at a greater distance from the comparatively hot object by the superposition of the respective temperature distributions gives rise, overall, to a more uniform temperature distribution.

With a view to such a more uniform temperature distribution, it is also advantageous to have a control or regulation of the temperature which is preferably carried out differently in different regions inside the construction space.

To determine suitable control parameters, for example, a simulation of the irradiation process may be carried out with a view to reducing the component distortion. It is particularly advantageous, for control purposes, to stipulate any, for example even nonlinear and time-variable, temperature distribution which has been optimized by means of a simulation of the laser sintering process with a view to a reduction in the component distortion. A corresponding simulation of the introduction of energy from a laser into the powder layers of the layer cake has already been proposed, for example in German patent application DE 100 50 280 A1. The resulting temperature distributions within the powder cake can likewise be determined by known methods, for example by solving the heat conduction equation, and, likewise, the influencing of this temperature distribution by the superposition of additional thermal control inside the construction space. Optimizing methods are likewise known to a person skilled in the art. Individual steps of the simulation can be verified experimentally or replaced.

To determine suitable regulation parameters, the actual temperature distribution on the material layer surface or else within the layer cake can be determined by means of known measurement methods and be used for regulating a more uniform temperature distribution.

Advantageously, at least one wall of the construction space is removed after thermal control in order to simplify the unpacking of the object.

With regard to the device to be provided for the production of a three-dimensional object made of a pulverulent material which can be compacted, the object is achieved by means of the following arrangements:
an arrangement for applying a layer of the material onto a target surface in a construction space,
an arrangement for smoothing the material layer,
an arrangement for irradiating a selected part of the material layer with an energy beam or material jet,
an arrangement for lowering the target surface inside the construction space,
   the device comprising at least one arrangement for flooding at least parts of the construction space with a fluid.

In this case, the target surface is, at the start of production, the construction space bottom and, during production, in each case the uppermost material layer of the layer cake being built up.

A suitable arrangement for flooding contains, for example, a pump or a compressor.

The arrangement according to the invention for flooding allows thermal control within the layer cake and therefore a reduction of component distortion, since the temperature distribution within the layer cake can thus be homogenized more effectively.

In an advantageous refinement, the device comprises at least one arrangement for the thermal control of the fluid, preferably for cooling the latter. A thermally controlled fluid, in particular a cooled fluid, can influence the temperature distribution within the layer cake markedly more effectively than a fluid which is not thermally controlled. This may be a gaseous or a liquid fluid.

Furthermore, it is advantageous if the construction space has at least one wall with at least one inlet or outlet orifice for the fluid. These orifices should be permeable to the fluid, but not to the powder of the layer cake.

Preferably, the construction space has at least one wall with a multiplicity of inlet or outlet orifices for the fluid which can be closed individually and/or in groups by means of closing arrangements according to requirements. A wall of this type may, for example, have a screen-like configuration.

Particularly advantageously, the device has at least one control or regulating arrangement for the separate control or regulation of different closing arrangements of inlet or outlet orifices for the fluid.

Likewise advantageously, at least one wall with orifices is arranged exchangeably in the construction space, preferably in such a way that different walls can be used which have different sizes, size distributions and/or arrangements of the orifices.

Additional advantages are afforded if the device comprises at least one arrangement for generating a vacuum, since the flow through the layer cake can consequently be promoted.

Likewise advantageously, the device has a plurality of thermal control arrangements for different fluid streams and also at least one control or regulating arrangement for the separate control or regulation of the various thermal control arrangements. Consequently, for example, an inhomogeneous temperature distribution in the construction space can be stipulated, the superposition upon which of the inhomogeneous temperature distribution as a result of the irradiation of the layer cake gives rise, overall, to a more homogeneous temperature distribution of the layer cake.

Alternatively or additionally, this homogenization may also be improved if the device has at least one control or regulating arrangement for the separate control or regulation of the various abovementioned inlet and/or outlet orifices and of the respective volume flows of the fluids. The regulating arrangement in this case comprises, if appropriate, a suitable measuring arrangement for detecting the actual temperature distribution in the layer cake or is connected to such a measuring arrangement.

The device according to the invention and the method according to the invention are explained in more detail below by means of an exemplary embodiment:

The exemplary device for the production of a three-dimensional object made of a pulverulent material which can be compacted is a commercially available laser sintering plant having the following arrangements:
an arrangement for applying a layer of the material onto a target surface in the construction space,
an arrangement for smoothing the material layer,
an arrangement for irradiating a selected part of the material layer with a laser beam,
an arrangement for lowering the target surface inside the construction space.

The commercially available laser sintering plant additionally has an arrangement for flooding at least parts of the construction space with a fluid, said arrangement being located outside the construction space, and also an arrangement for controlling the flooding arrangement.

The flooding arrangement comprises a gas accumulator, a thermal control arrangement for the gas and also a pump for conveying a gas stream. The flooding arrangement is connected, gas-tight, to a plurality of inlet orifices in the construction space bottom of screen-like configuration.

Beneath the construction space bottom lowerable in the usual way is located a multiplicity of inlet orifices for the fluid which can be closed individually and/or in groups by means of closing arrangements according to requirements. The opening or closing of the closing arrangements is controlled according to requirements via the control arrangement, for example via a commercially available PC.

The top side of the construction space is closed, gas-tight, and is connected to a suction-extraction arrangement which generates a slight vacuum and which thus promotes the flow through the layer cake. The suction-extracted gas is recirculated into the gas accumulator.

According to this exemplary embodiment, the production of the object also takes place in the usual way by means of the known method of selective laser sintering, thermal control taking place within the layer cake.

For this thermal control, first, suitable control parameters for the thermal control arrangement are determined. For this purpose, first, a simulation of the customary irradiation process is carried out, and the temperature distribution occurring in this case is calculated. Subsequently, a corresponding simulation is carried out for the arithmetic optimization of an additional thermal control, to be superposed, as a result of a thermally controlled throughflow of the interior of the construction space, with a view to minimizing the component distortion.

By means of the control parameters determined in this way, the thermal control arrangement for the gas flowing through, the volume flow of the latter and also the individual closing orifices are activated during the laser sintering method which otherwise proceeds in the usual way.

The additional thermal control (as well as the thermal control as a result of irradiation) within the layer cake reduces component distortion, since the temperature distribution within the layer cake, particularly within a layer of the layer cake, can thus be homogenized more effectively and can fall more uniformly from the irradiated regions of the surface as far as the bottom of the construction space.

The thermal control of the fluid takes place variably in time, in that it is regularly adapted to the temperature of the layer cake. For this purpose, the temperature of the layer cake is measured in real time in a stipulated position. Adaptation takes place in such a way that a limit value of the temperature difference between the fluid and layer cake is not overshot, in order, for example, to minimize influences on account of thermal stresses within the layer cake. By the thermal control of the fluid being regulated, the temperature difference between the fluid and layer cake is kept constant during the cooling of the layer cake.

The device according to the invention and the method according to the invention prove, in the embodiments of the example described above, to be particularly suitable for rapid manufacturing applications in the automobile industry.

In particular, a marked improvement in component quality in terms of thermally induced distortion can thus be achieved. Moreover, the invention may be utilized in order to increase productivity, since it makes it possible to produce a plurality of components simultaneously in one large construction space. The mutually superposed temperature distributions of a plurality of components have hitherto given rise to unacceptable component distortions. By means of the device according to the invention and the method according to the invention, in the case of a plurality of components the component distortion can be minimized by means of suitable thermal control inside the construction space, in particular between adjacent component limits. This also makes it possible to enlarge the construction space to scales which it has not been possible to use hitherto.

By means of numerical optimization methods (for example, FEM simulation), the packaging, as it is known, that is to say the distribution of a plurality of components in one construction space, can be optimized. As a result, a maximum number of components can be produced simultaneously in one construction space under optimal temperature conditions.

1. A method for the production of a three-dimensional object, comprising:
applying and smoothing a compactable pulverulent material layer onto a target surface,
irradiating a selected part of the layer with an energy beam or material jet according to a cross section of the object,
so that the material layer is compacted in this selected part,
the irradiated parts and their surroundings being heated,
repeating said applying and smoothing for a plurality of layers
which form a layer cake, so that the compacted parts of the adjacent layers bond together in order to form the object, a fluid flowing at least partially through the layer cake,
wherein at least one wall of a construction space is removed after thermal control in order to simplify the unpacking of the object.

2. The method according to claim 1,
wherein the fluid is thermally controlled.

3. The method according to claim 1, wherein
the fluid penetrates through at least one wall of the construction space having a multiplicity of inlet or outlet orifices for the fluid.

4. The method according to claim 1, wherein
a control or regulation of the temperature by the fluid locally flowing through takes place by complete or partial opening or closing of various closing arrangements of the inlet or outlet orifices for the fluid.

5. A device for the production of a three-dimensional object made of a pulverulent material which can be compacted, comprising
an arrangement for applying a layer of the material onto a target surface in a construction space,
an arrangement for smoothing the material layer,
an arrangement for irradiating a selected part of the material layer with an energy beam or material jet,
an arrangement for lowering the target surface inside the construction space,
the device comprising at least one arrangement for flooding at least parts of the construction space with a fluid,
wherein the construction space has at least one wall with a multiplicity of inlet or outlet orifices for the fluid which can be closed individually or in groups by closing arrangements according to requirements, the at least one wall with orifices being arranged exchangeably in the construction space.

6. The device according to claim 5,
wherein the device comprises at least one arrangement for the thermal control of the fluid.

7. The device according to claim 5,
wherein the construction space has at least one wall with at least one inlet or outlet orifice for the fluid.

8. The device according to claim 5, wherein
the device has at least one control or regulating arrangement for the separate control or regulation of different closing arrangements of inlet or outlet orifices for the fluid.

9. The device according to claim 5, wherein
the at least one wall with orifices is arranged exchangeably in the construction space so that different walls can be present which have different sizes, size distributions, arrangements of the orifices, or a combination thereof.

10. The device according to claim 5, wherein
the device comprises at least one arrangement for generating a vacuum.

11. The method according to claim 1, wherein the fluid is cooled.

12. The device according to claim 5, wherein the device comprises at least one arrangement for cooling the fluid.

13. The method according to claim 3, wherein said orifices are closed individually or in groups by closing arrangements according to requirements.
